(19) United States
(12) Patent Application Publication
(10) Pub. No.: US 2002/0051165 A1
(43) Pub. Date: May 2, 2002

(54) Image processing device and image data conversion method

(76) Inventors: Kenji Morita, Kawagoe-shi (JP); Hitoshi Sato, Kawagoe-shi (JP); Toshiyuki Murata, Kawagoe-shi (JP); Rie Yamashita, Kawagoe-shi (JP); Yukari Mizumura, Kawagoe-shi (JP)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/843,649

(22) Filed: Apr. 27, 2001

(30) Foreign Application Priority Data
Apr. 28, 2000 (JP) 2000-131605

(51) Int. Cl. G06F 15/00

(52) U.S. Cl. 358/1.13

(57) ABSTRACT

An image processing device and image data conversion method, which, in the case where a plurality of images are to be displayed simultaneously on the same display screen, realizes the expression of colors suited to the designs of the respective images, without biasing of the tints of the respective images displayed on the screen, by a simple arrangement and without making the ROM capacity large. N-bit image data and color pallet data corresponding to each of the n-bit image data are stored in a ROM, and in the process of transferring the image data via an image data processing part to a VRAM, the image data are converted into m-bit (where n<m) image data that are then subject to processing by a GDC (Graphics Display Converter) as they are and displayed on display monitor. Here, image data processing part converts the n-bit image data to m-bit image data by collation of the n-bit image data with the m-bit color pallet data.

### BACKGROUND OF THE INVENTION

1. Field of the Invention

This invention relates to an image processing device and an image data conversion method, in particular, an image processing device and an image data conversion method, which are favorable for employment in a display device and by which image data are read out from a ROM and transferred to a VRAM to obtain the desired display.

2. Description of Related Art

FIG. 1 shows the general arrangement of an example of a prior-art image processing device. The image processing device shown here is comprised of a microcomputer 101, which serves as the center of control, a graphics display controller (GDC) 102, which applies drawing and coloring processes on image data, and a ROM 103 and VRAM (Video RAM) 104 for storing the image data. 105 denotes a liquid crystal or other type of display monitor, 106 denotes a controlling microcomputer, and 107 denotes a remote controller or other type of operation part.

In order to perform the desired image display on display monitor 105, microcomputer 101 controls ROM 103, VRAM 104, and GDC 102 by sending control signals Sa, Sb, and Sc, respectively. That is for example, control signal Sa is sent to ROM 103, which stores 8-bit image data that can be displayed in 256 colors and color pallet data that indicate the respective color tone levels of R (red), G (green), and B (blue), and based on the control signal Sa, ROM 103 sends the 8-bit image data and the color pallet data to VRAM 104. Based on the control signal Sb sent from microcomputer 101, VRAM 104 stores the transferred 8-bit image data and the color pallet data in areas corresponding to the address numbers that indicate the order of display on monitor 105 and transfers the stored image data to GDC 102 in the order starting from lower address numbers,. Based on the control signal Sc from microcomputer 101, GDC 102 performs a coloring process using the color pallet data on the image data transferred from VRAM 104. These color processed image data are then displayed as image information on display monitor 105.

The 8-bit image data that are stored in ROM 103 are thus processed as they are at GDC 102 and displayed as images.

With the above-described prior-art image processing device, ROM 103 stores color pallet data that are used in common on 8-bit image data for a plurality of image information to be displayed on display monitor 105. For example, in the case where 3 images of the background image information, icon image information, and information dependent on the OS are displayed simultaneously on display monitor 105, the same color pallet data will be used for the 8-bit image data concerned with these image information, and thus if green color pallet data are used to express the colors of the background image information, the other image information will also be expressed in a greenish color. The image information displayed on display monitor 105 will thus be mutually of the same type of color and the tint will be biased. The expression of colors suited to the designs of the respective image information was thus considered difficult.

Though the storing of 16-bit image data (approximately 65000 colors) in ROM 103 has been considered for expressing colors suited to the design, high cost and other problems occur since approximately twice the ROM capacity required for 8-bit image data will be required in this case.

### OBJECTS AND SUMMARY OF THE INVENTION

The present invention has been made in view of the above circumstances, and an object thereof is to provide an image processing device and an image data conversion method, with which the ROM capacity does not have to be made large for storing n-bit image data and m-bit color pallet data, corresponding to these image data, in the ROM and transferring the image data to the VRAM and with which, by a simple arrangement, clear image information, suited to the design of the image information, can be displayed without biasing of the tint of image information even when a plurality of image information are displayed simultaneously on a monitor, etc.

In order to achieve the above object, according to a first aspect of this invention, there is provided an image processing device, comprised of a first storage device, which stores n-bit image data, an image data converter, which converts the n-bit image data into m-bit (where n<m) image data, and a second storage device, which stores the m-bit image data resulting from data conversion, and wherein the first storage device stores m-bit color pallet data corresponding to the n-bit image data and the image data converter converts the n-bit image data into m-bit image data by collation of the n-bit image data with the m-bit color pallet data and then transfers the m-bit image data to the second storage device.

By the above arrangement, the n-bit image data and the m-bit color pallet data, which respectively corresponding to each of the n-bit image data, are stored in the first storage device, and the image data are converted to m-bit image data in the process of transfer to the second storage part via the image data converter. An image processing device can thus be provided with which detailed images can be displayed by a simple arrangement and without making the ROM capacity large.

According to a second aspect of this invention, there is provided an image processing device, which is comprised of a first storage device, which stores n-bit image data, an image data converter, which converts the n-bit image data into m-bit (where n<m) image data, a second storage device, which stores the m-bit image data resulting from data conversion, and a display device, which displays, as image information, the m-bit image data read out from the second storage device and wherein the image data converter converts the n-bit image data, stored in the first storage device, into m-bit image data for each pixel that comprises the image information that is to be displayed on the display device and then transfers the m-bit image data to the second storage device.

According to a third aspect of this invention, in an above-described image processing device, the image data converter successively acquires the n-bit image data for a single image information, which have been transferred from the first storage device, and the m-bit (where n<m) color pallet data corresponding to the image data, acquires the color pallet data for each pixel that comprises the above mentioned single image information, and then performs transfer to the second storage device.

By the above arrangement, n-bit image data and m-bit color pallet data, corresponding to each of the n-bit image data, are stored in the first storage device and the image data are converted to m-bit image data for each pixel in the process of transferring the image data to the second storage device via image data converter and are then supplied to the display device to obtain the desired display. Thus in the case where a plurality of images are used and displayed at the same time on the display device, colors suited to the design of each image can be expressed without biasing of the tints of the respective images displayed on the display device and an image processing device can be provided with which detailed images can be displayed by a simple arrangement and without making the ROM capacity large.

According to a fifth aspect of this invention, there is provided an image data conversion method, with which n-bit image data, stored in a first storage device, and m-bit (where n<m) color pallet data, which correspond to the image data and are stored in the first storage device, are used to perform conversion and wherein the n-bit image data and the m-bit color pallet data are acquired from the first storage device and the n-bit image data are converted to m-bit image data by collation of the acquired n-bit image data with the above mentioned m-bit color pallet data.

Thus in the case where a plurality of images are used and displayed at the same time on the display device, colors suited to the design of each image can be expressed without biasing of the tints of the respective images displayed on the display device and detailed images can be displayed by a simple arrangement and without making the ROM capacity large.

### BRIEF DESCRIPTION OF THE DRAWINGS

FIG. 1 is a block diagram, which shows an arrangement of an example of prior-art image processing devices.

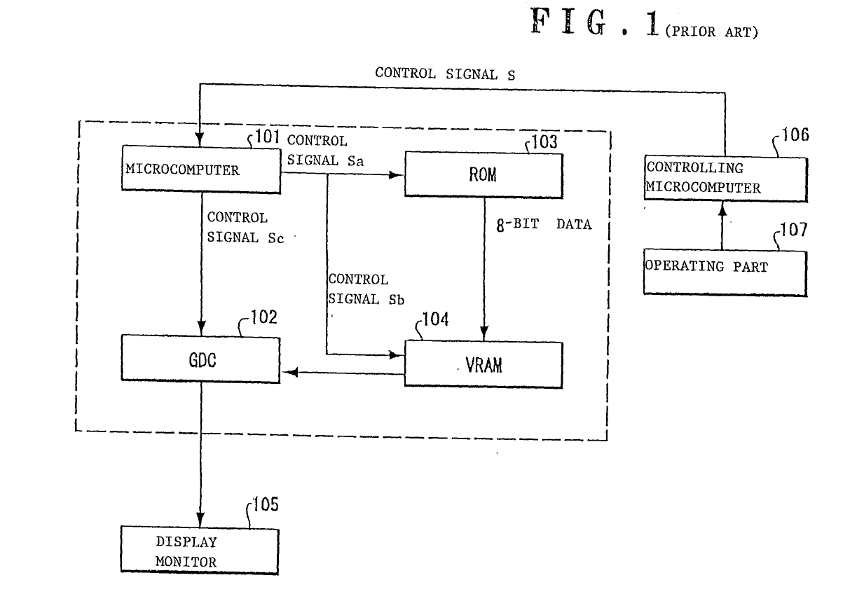

FIG. 2 is a block diagram, which shows an embodiment of this invention.

FIG. 3 is a diagram, which shows the display screen arrangement of a display monitor used in the embodiment of this invention.

FIG. 4 is a diagram, which shows the data structure of a ROM used in the embodiment of this invention.

FIG. 5 is a diagram for explaining the details of the address data and size data shown in FIG. 4.

FIG. 6 is a diagram, which shows the details of a single image information prepared based on the size data.

FIG. 7 is a diagram for explaining the operation of the embodiment of this invention and is a diagram, which shows, in a conceptual manner, the manner in which 8-bit image data are converted into 16-bit image data.

FIG. 8 is a diagram, which shows the data structure of a VRAM used in the embodiment of this invention.

FIG. 9 is a flowchart, which is for explaining the operation of the embodiment of this invention shown in FIG. 2 and shows the operation of the entire image processing device.

FIG. 10 is a flowchart, which is for explaining the operation of the embodiment of this invention shown in FIG. 2 and shows the procedure for data conversion by an image data processing part.

### DETAILED DESCRIPTION OF THE EMBODIMENT

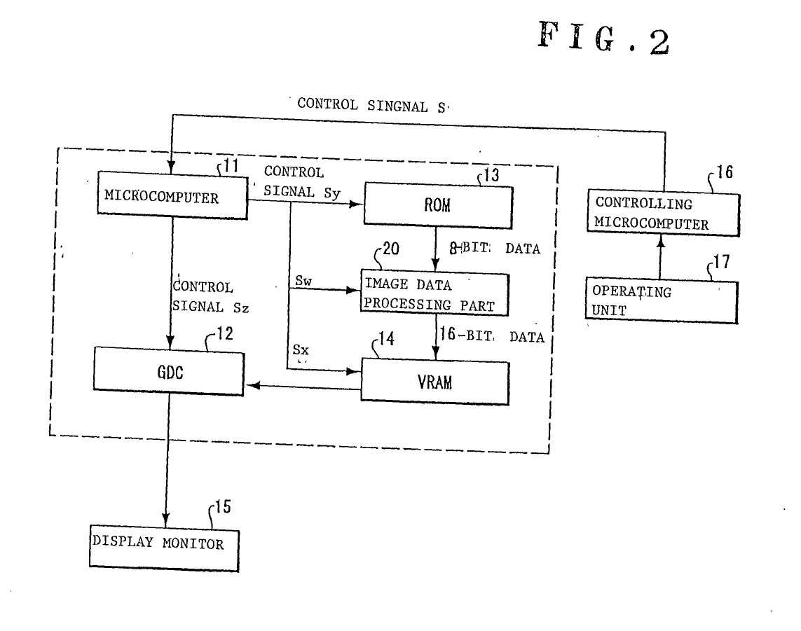

An embodiment of an image processing device and image data conversion method by this invention shall now be described by way of FIGS. 2 through 10.

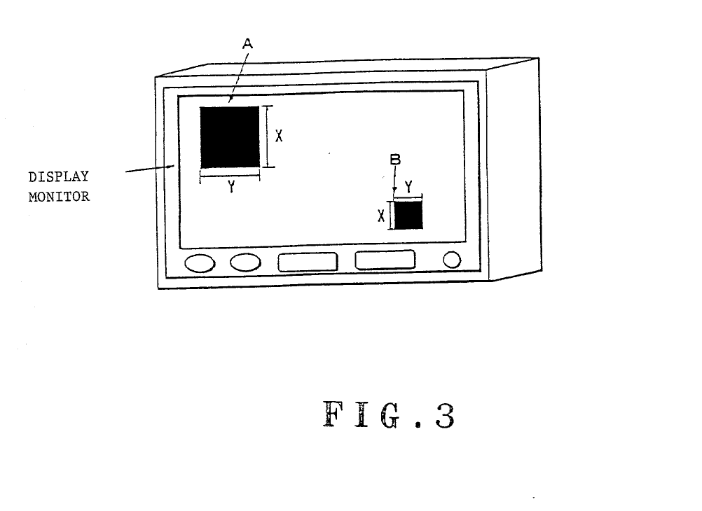

FIG. 2 is a block diagram, which shows an embodiment of an image processing device by this invention. FIG. 3 is a diagram, which shows, in a simplified manner, the display screen arrangement of a display monitor 15 used in the embodiment of the image processing device by this invention.

In FIG. 2, the reference numeral 11 denotes a microcomputer, which is the center of control of the image processing device of this invention. This microcomputer 11 performs control for image processing based on a control signal S from controlling microcomputer 16. 12 denotes a GDC. Based on a control signal Sz from microcomputer 11, GDC 12 performs the processes of writing, D/A conversion, etc. of image data transferred from VRAM 14. GDC 12 also outputs the processed image data to a display monitor 15 in synchronization with the display timing of display monitor 15.

Image data that are output from this GDC 12 are displayed as image information on the display monitor 15 shown in FIG. 2. This image information corresponds to image data, which have been allocated to a display size on the screen of display monitor 15 based on size data (X, Y), to be described below, and as shown in the Figure, a plurality of image information A and B can be displayed simultaneously on the screen of display monitor 15.

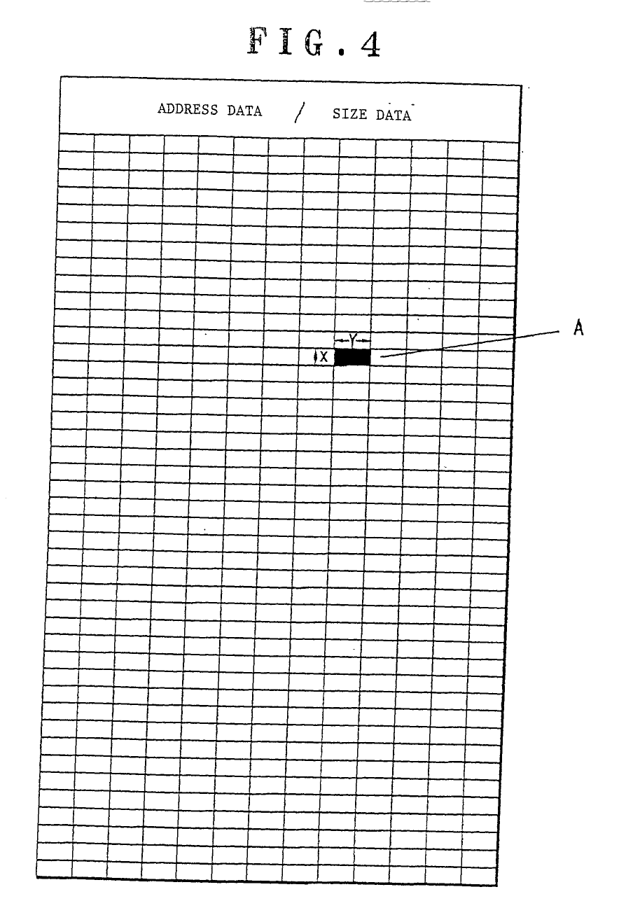

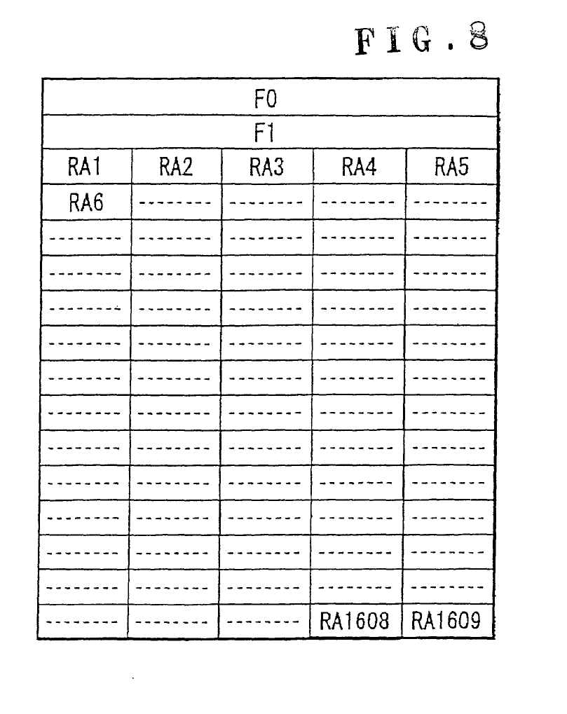

The reference numeral 13 denotes a ROM. ROM 13 stores, for example, 8-bit image data and 16-bit color pallet data, which correspond to the image data. Based on a control signal Sy from microcomputer 11, ROM 13 transfers the 8-bit image data and the corresponding 16-bit color pallet data for each image information to an image data processing part 20. The data structure of ROM 13 shall be described below with reference to FIG. 4. The reference numeral 14 denotes a VRAM. Based on a control signal Sx from microcomputer 11, VRAM 14 stores the image data, that have been transferred from image data processing part 20, in areas corresponding to the address numbers that indicate the order of display on display monitor 15 and, in the order starting from lower address numbers, VRAM 14 transfers the image data, which have been stored in the corresponding areas, to GDC 12. The data structure of VRAM 14 shall be described with reference to FIG. 8.

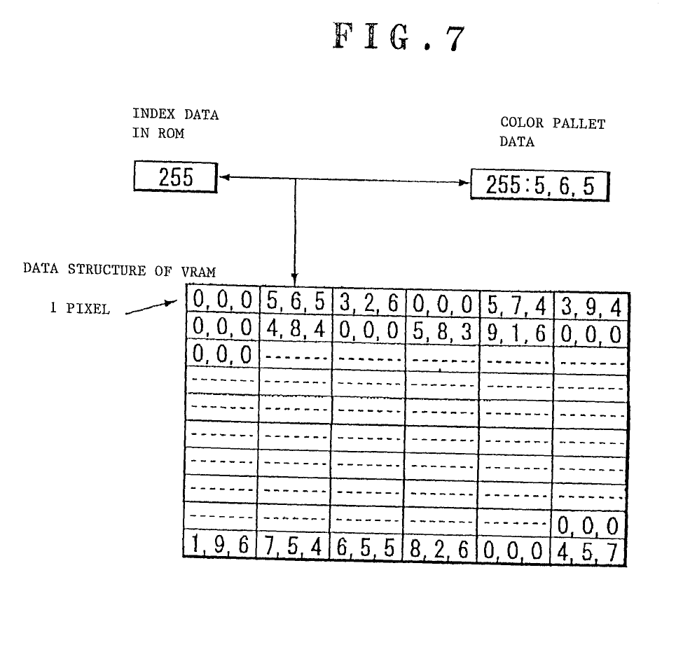

Based on a control signal Sw from microcomputer 11, image data processing part 20 collates the 8-bit image data for each image information that have been transferred from ROM 13 with the 16-bit color pallet data transferred along with the image data to thereby convert the 8-bit image data into 16-bit image data and transfers the converted image data to VRAM 14. The data conversion process at image data processing part 20 shall be described below with reference to FIG. 7.

The reference numeral 15 denotes a liquid crystal or other type of display monitor, 16 denotes a controlling microcomputer, and 17 denotes an operating part. An example where the image processing device of this invention is applied as a console for an audio visual device, such as a DVD (Digital Versatile Disk) player is illustrated here, and thus controlling microcomputer 16 scans instructions by means of an operating part 17, which may be a remote controller, etc., and notifies these instructions to microcomputer 11 so that the desired display control will be carried out.

FIG. 4 is a diagram, which shows the data structure of ROM 13, which is used in the embodiment of this invention. As can be understood from this Figure, address data and size data are stored in the upper addresses of ROM 13. 8-bit image data for approximately 1609 pixel information are stored in the subsequent addresses. Though the data are expressed here as having the same dimensions in order to facilitate understanding of this invention, the data are actually stored as continuous data. That is, the dimensions X (number of pixels in the vertical direction) and Y (number of pixels in the horizontal direction) of a data are allocated by the size data at an upper address to form image data for a single image information (the portion indicated by A).

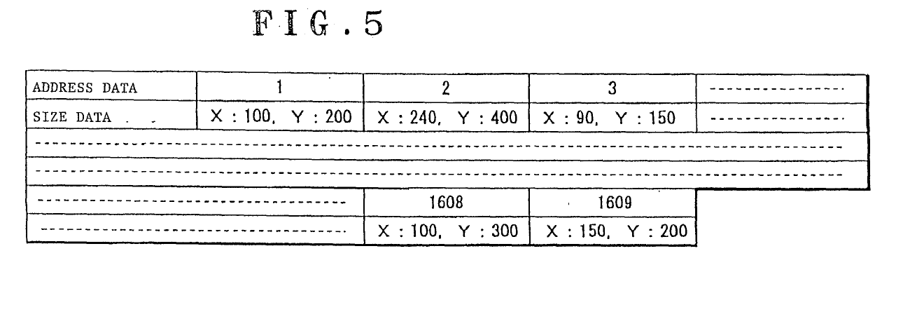

FIG. 5 is a diagram for explaining the details of the address data and size data shown in FIG. 4. Here, consecutive numbers from 1 to 1609 are allocated as address data and the size data, indicating the dimensions X (number of pixels in the vertical direction) and Y (number of pixels in the horizontal direction), are stored in correspondence to the address data. That is, 8-bit image data corresponding to an address are allocated for a single image information based on the size data and transferred to image data processing part 20.

For example, for the data shown in this Figure, in the case where allocation of the image data corresponding to address data 2 is to be performed based on the control signal S from microcomputer 11, the image data corresponding to this address data are searched from among the image data stored in a continuous manner in the ROM 13 shown in FIG. 4. By the allocation of the found data to 240 pixels in the vertical direction and 400 pixels in the horizontal direction, 8-bit image data are prepared for a single image information.

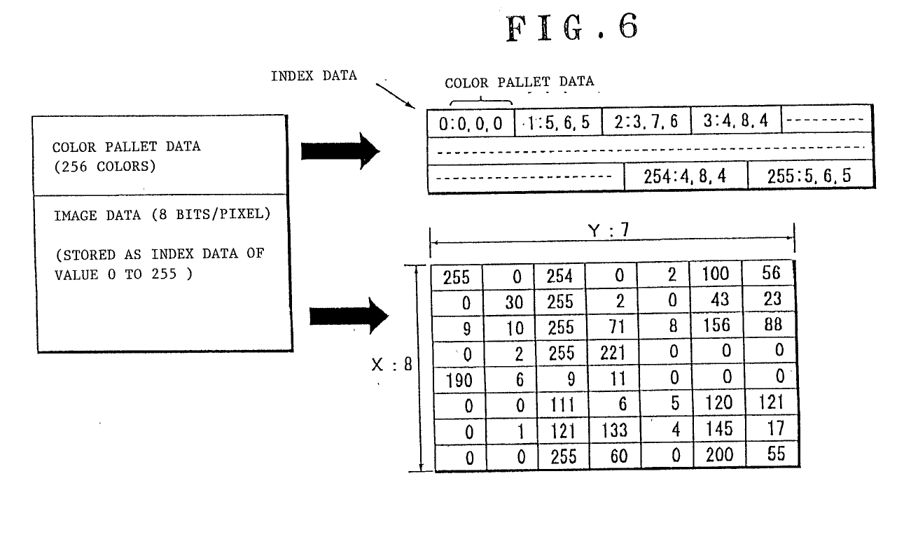

FIG. 6 shows the details of 8-bit image data for a single information that have been allocated based on the size data and the color pallet data corresponding to these image data. The color pallet data are comprised of index data and 16-bit color pallet data that correspond to the index data and indicate the respective color tone levels of R (red), G(green), and B (blue). Though normally 16-bit color pallet data express approximately 65000 colors, the embodiment of this invention employs 16-bit color pallet data for 256 colors selected from among the 65000 colors. For example, with the data “1: 5, 6, 5” shown in the Figure, the “1” at the left side is the index data and this is controlled as a numeral that corresponds to the 8-bit image data to be described below. The “5, 6, 5” at the right side indicate the 16-bit color pallet data. The left numeral “5” indicates the R (red) color tone level, the central numeral “6” indicates the G (green) color tone level, and the right numeral “5” indicates the B (blue) color tone level. A color that is in accordance with these color tone levels will be expressed.

Each of the 8-bit image data for single image information that have been allocated based on the size data is expressed and stored as index data for each pixel that comprises the image information. As has been mentioned above, these image data correspond to the index data of the color pallet data. For example, with the data shown in this Figure, the single image information is allocated 8 pixels in the vertical direction and 7 pixels in the horizontal direction and is comprised of 8×7=56 pixels. That is, an 8-bit image data is stored for each of the 56 pixels.

FIG. 7 is a diagram, which shows, in a conceptual manner, the manner in which 8-bit image data are converted into 16-bit image data at image data processing part 20. That is, as the conversion method, the 8-bit image data (index data) and the index data of the color pallet data in the ROM are collated and a 16-bit color pallet data is stored for each pixel in VRAM 14. As can be understood from the data shown in this Figure, the 8-bit image data (index data: 255) stored in ROM 13 is collated with the color pallet data index data of the same numeral, in other words, the index data, “255”, and the 16-bit color pallet data “5, 6, 5” for this index data is stored as 16-bit image data at the pixel position corresponding to the 8-bit image data. This collation of index data with each other may be performed by a software logic method or a hardware logic method. In either case, for each pixel that comprises a single image information, a 16-bit image data, expressed in the R (red), G (green), and B (blue) color tone levels, is stored in VRAM 14. Since this 16-bit image data uses the 16-bit color pallet data, a coloring process is applied at image data processing part 20 in the process of storage in VRAM 14.

FIG. 8 is a diagram, which shows the data structure of VRAM 14. Here, the image data that have been converted into 16 bits are stored in the areas RA1, RA2, . . . in accordance with the address numbers that indicate the order of display on display monitor 15, which is controlled in advance by microcomputer 11.

In this figure, the immediate 16-bit image data that are to be displayed on display monitor 15 are transferred and stored in the respective areas of F0 and F1 in accordance with above mentioned areas RA1, RA2, RA3, . . . in the order starting from lower address numbers. In other words, the 16-bit image data stored in the respective areas of F0 and F1 are subject to such processing as D/A (Digital/Analog) conversion, positioning of image data to the dot positions of display monitor 15, etc. by GDC 12 and then displayed on display monitor 15.

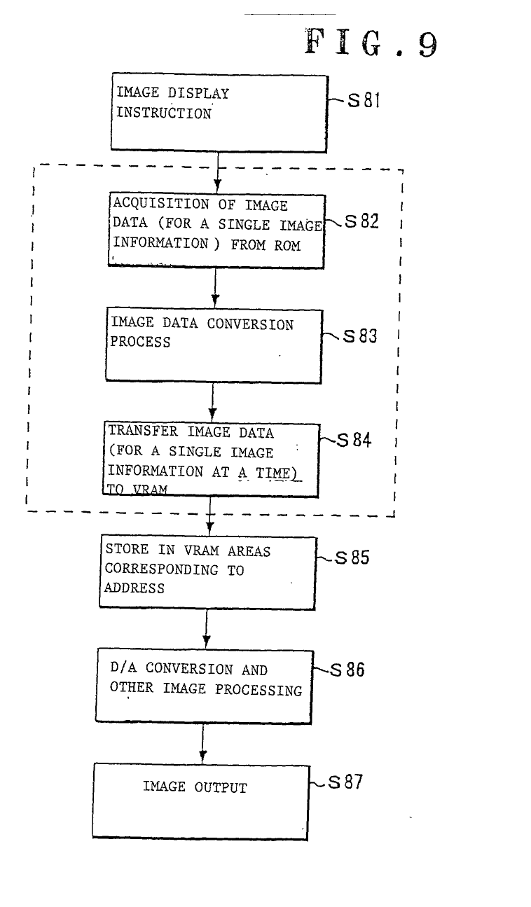

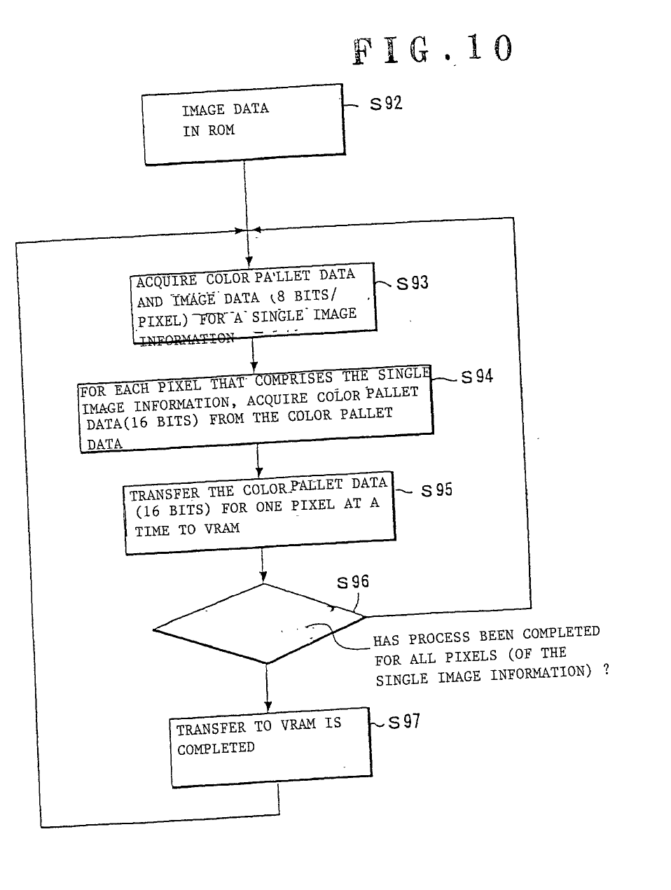

FIGS. 9 and 10 show, in the form of flowcharts, the operation of the image processing device of the embodiment of this invention and the procedure for the conversion operation by image data processing part 20.

The image processing operation and the image data conversion operation shall now be described in accordance with FIGS. 9 and 10.

In FIG. 9, first, microcomputer 11 receives control signal S, which is the image display instruction, from controlling microcomputer 16, which had received an operation command from operating part 17, and sends control signal Sy to ROM 13 (step S81). Upon receiving the control signal Sy from microcomputer 11, ROM 13 acquires 8-bit image data for a single image information based on the size data of the number of pixels in the vertical direction (X) and the number of pixels in the horizontal direction (Y) and transfers these image data along with the corresponding color pallet data to image data processing part 20 (step S82). Next, based on the control signal Sw from microcomputer 11, image data processing part 20 performs the conversion process of the 8-bit image data in accordance with the procedure shown in FIG. 9 (step S83) and sends 16-bit image data for each single image information to VRAM 14.

In FIG. 10, image data processing part 20 acquires the 8-bit image data for each single image information that were transferred from ROM 13 and the color pallet data corresponding to the image data (step S93). Next, the 8-bit image data for one pixel that comprises a single image information and the index data of the color pallet data are collated to acquire a 16-bit color pallet data (step 94). The 16-bit color pallet data thus obtained is then transferred as 16-bit image data to the corresponding pixel position in an area among the areas RA1, RA2, . . . of VRAM 14 (step 95). Microcomputer 11 then judges whether or not all of the pixels that comprise the single image information have been converted into 16-bit image data (step S96), and if it is judged that this has not been completed (step S95: NO), controls image data processing part 20 to continue the conversion process. When microcomputer 11 judges that the process has been completed (step S96: YES), all of the pixels that comprise the single image information will have been converted into 16-bit image data and transferred to VRAM 14 (step S97) and microcomputer 11 then controls image data processing part 20 to repeat the above-described conversion process for the next image information from ROM 13.

Returning now to FIG. 9, the VRAM 14, which has received the transfer of image data for single image information that have been converted into 16 bits, stores these image data in the respective areas RA1, RA2, . . . corresponding to the addresses and based on control signal Sx from microcomputer 11. The immediate 16-bit image data to be displayed on display monitor 15 are then transferred to either of the areas F0 or F1 in accordance with the addresses (step S85). Based on the control signal Sz from microcomputer 11, GDC 12 performs D/A conversion and other processes on the transferred 16-bit image data (step S86) and outputs these data as image information to display monitor 15 (step S87).

The series of image information processes of converting the 8-bit image data stored in ROM 13 into 16-bit image data and displaying them on display monitor 15 are thus carried out under the control of microcomputer 11.

As has been described above, with the image processing device of this invention, n-bit image data and color pallet data corresponding to each of the n-bit image data are stored in ROM 13, these data are converted into m-bit (where n<m) image data in the process of transfer to VRAM 14 and processed as they are by GDC 12 and then displayed on display monitor 15. Detailed images can thus be displayed by a simple arrangement and without making the capacity of ROM 13 large.

Though an example where image data of n=8 bits, stored in ROM 13, were written into VRAM 14 upon conversion into image data of m=16 bits was described with the embodiment of this invention, the bit capacity may be of any size as long as n and m are both integers and the relationship, n<m, is satisfied.

As has been described above, with the present invention, by storing n-bit image data and m-bit color pallet data, corresponding to each of the n-bit image data, and converting these image data into m-bit (where n<m) image data in the process of transfer to VRAM 14, detailed images can be displayed without making the capacity of the ROM large.

Also by storing n-bit image data and color pallet data, corresponding to each of the n-bit data, in a first storage device, converting each of the image data to m-bit image data for each pixel in the process of transferring the image data to a second storage device via an image data converter, and supplying the converted data to a display device to obtain the desired display, colors suited to the designs of the respective images can be expressed, without the tints of the respective images to be displayed on the display device becoming biased, for example, in the case where a plurality of images are used and displayed simultaneously on the display device, and an image processing device can be provided with which detailed images can be displayed by a simple arrangement and without making the capacity of the ROM large.

This application is based on Japanese Patent Application No. 2000-131605 which is hereby incorporated by reference.

What is claimed is:

1. An image processing device, comprised of a first storage device, which stores n-bit image data,
an image data converter, which converts said n-bit image data into m-bit (where n<m) image data, and
a second storage device, which stores said m-bit image data resulting from data conversion,
said image processing device being characterized in that said first storage device stores m-bit color pallet data corresponding to said n-bit image data and said image data converter converts said n-bit image data into m-bit image data by collation of said n-bit image data with said m-bit color pallet data and then transfers said m-bit image data to said second storage device.

2. An image processing device, comprised of a first storage device, which stores n-bit image data,
an image data converter, which converts said n-bit image data into m-bit (where n<m) image data,
a second storage device, which stores said m-bit image data resulting from data conversion, and
a display device, which displays, as image information, said m-bit image data read out from said second storage device,
said image processing device being characterized in that said image data converter converts said n-bit image data, stored in said first storage device, into m-bit image data for each pixel that comprises said image information that is to be displayed on said display device and then transfers said m-bit image data to said second storage device.

3. An image processing device as set forth in claim 1, wherein said image data converter successively acquires said n-bit image data for single image information that have been transferred from said first storage device and the m-bit (where n<m) color pallet data corresponding to the image data and acquires said color pallet data for each pixel that comprises said single image information and then transfers converted m-bit imaged data to said second storage device.

4. An image processing device as set forth in claim 2, wherein said image data converter successively acquires said n-bit image data for single image information that have been transferred from said first storage device and the m-bit (where n<m) color pallet data corresponding to the image data and acquires said color pallet data for each pixel that comprises said single image information and then transfers converted m-bit data to said second storage device.

5. An image data conversion method, with which n-bit image data, stored in a first storage device, and m-bit (where n<m) color pallet data, which correspond to the image data and are stored in the first storage device, are used to perform conversion, said image data conversion method being characterized in that the n-bit image data and the m-bit color pallet data are acquired from said first storage device and the n-bit image data are converted to m-bit image data by collation of the acquired n-bit image data with said m-bit color pallet data.
